(19) United States
(12) Patent Application Publication
(10) Pub. No.: US 2014/0069832 A1
(43) Pub. Date: Mar. 13, 2014

(54) SYSTEM MODULE

(71) Applicant: Heiko Roehm, Heiko (DE)

(72) Inventor: Heiko Roehm, Heiko (DE)

(73) Assignee: Robert Bosch GmbH, Stuttgart (DE)

(21) Appl. No.: 14/116,466

(22) PCT Filed: Mar. 15, 2012
(86) PCT No.: PCT/EP2012/054577

§ 371 Date: Nov. 8, 2013

(30) Foreign Application Priority Data
May 10, 2011 (DE) 10 2011 075 581.0
Sep. 6, 2011 (DE) 10 2011 082 155.4

(51) Int. Cl. B25H 3/02

(52) U.S. Cl. CPC B25H 3/02
USPC 206/349

(57) ABSTRACT

A system module of a case system includes at least one functional unit different from a portable tool and at least one housing element that includes at least one coupling device. The coupling device is configured to couple to a system case and to be released by a user. The system module has a damping mechanism configured to fasten the functional unit to the housing element in a damped manner.

### PRIOR ART

The invention proceeds from a system module of a box system according to the preamble of claim 1.

There has already been proposed, in the publication DE 10 2008 058 007 B3, a system box having at least one housing element, which comprises a coupling device for coupling to a further system box so as to be releasable by an operator. Furthermore, boxes having a function unit that is different from a hand tool are also known.

### DISCLOSURE OF THE INVENTION

The invention proceeds from a system module of a box system, having at least one function unit that is different from a hand tool, and having at least one housing element, which comprises at least one coupling device for coupling to a system box so as to be releasable by an operator.

It is proposed that the system module have a damping means, which is provided to fasten the function unit to the housing element in a damped manner. A “housing element” is to be understood to mean, in particular, an element provided to enclose, at least partially, a function-unit receiving region for receiving the function unit. Preferably, the housing element, if properly used, in particular in the case of transport of an object in the receiving region, and in the case of storage and stacking, is at least substantially dimensionally stable. This means, in particular, that the housing element, if properly used, becomes deformed, in particular elastically, by less than 20%, advantageously by less than 5%, of a main extent of the housing element. Preferably, the housing element has a housing body made of a metal and/or, particularly preferably, of a plastic such as, for example, PA6, ABS, PC, PP and/or another plastic considered appropriate by persons skilled in the art. Advantageously, the housing element has at least one standing surface provided to enable secure standing, at least on an inclined plane having a slope of at least 10 degrees. Preferably, at least the standing surface is slip resistant and/or preferably protected against impact. Preferably, the housing element comprises the damping means. A “coupling device” is to be understood to mean, in particular, a device provided to connect the system module according to the invention and the system box, or a further system module according to the invention, such that they are immovable relative to each other, in at least one operating state. Preferably, the coupling device is realized as described in the publication DE 10 2008 058 007 B3. Alternatively, the coupling device could be realized in a different manner, considered appropriate by persons skilled in the art. In particular, “coupling so as to be releasable by an operator” is to be understood to mean a mechanical connection that, for the purpose of spatial separation of the system module according to the invention and the system box, or the further system module, can be opened by the operator in a non-destructive manner. Preferably, the coupling can be undone by the operator without the use of tools. A “system module” is to be understood to mean, in particular, a module having a receiving region, for transporting an object, which is provided to act in combination with at least one other system box and/or system module for the purpose of achieving a functionality, in particular at least comfortable transport. Preferably, the system module according to the invention encloses the receiving region, in particular on one plane, on at least four sides.

Preferably, the system module according to the invention encloses the receiving region on one plane by at least 270 degrees, particularly preferably by 360 degrees. In particular, a “damping means” is to be understood to mean a means provided to mount the function unit such that it is movable relative to the housing element by at least 2 mm, advantageously at least 4 mm, particularly advantageously at least 10 mm, for the purpose of damping at least an acceleration of the housing element, for example in the case of an impact upon the housing element following a drop. Preferably, the acceleration of the housing element at which this relative movement is achieved is at least greater than 50 m/s² and less than 500 m/s², at at least one instant. For example, the acceleration of the housing element could be caused by an impact in the case of a drop from a height of 50 cm. In particular, if the function unit is displaced relative to the housing element, the damping means exerts a force upon the function unit. Preferably, the damping means undergoes visco-elastic deformation upon the displacement. Alternatively, the damping means could undergo elastic deformation upon the displacement. Advantageously, after a displacement, the damping means moves the function unit back into an original position. Preferably, the damping means, in a region that transmits a force upon the acceleration of the housing element, has at least an extent greater than 5 mm, preferably greater than 10 mm, particularly preferably greater than 20 mm, in a direction of the force. Preferably, the damping element has a modulus of elasticity of less than 2 kN/mm², advantageously less than 0.5 kN/mm², particularly advantageously less than 0.1 kN/mm². “Provided” is to be understood to mean specially configured and/or equipped. In particular, a hand tool is to be understood to mean a drill, a hammer drill, a saw, a plane, a screwdriver, a router, a sander and/or an angle grinder. Preferably, the damping means is provided to fasten a function unit, that is other than a hand-tool battery, to the housing element in a damped manner. In particular, a “function unit” is to be understood to mean a unit provided to perform a main function in an operating state in which it is fastened by the damping means. Preferably, the function unit has at least one function considered appropriate by persons skilled in the art, but advantageously at least an illumination means, a charging device, a measuring device, a leveling device, an energy output, in particular a socket outlet and/or, particularly advantageously, a media reproduction device, in particular with a radio. The term “fasten” in this context is to be understood to mean, in particular, that the damping means is provided to align the function unit relative to the housing element. Advantageously, the housing element and/or, preferably, the damping means is provided to fasten the function unit during operation of the function unit. In particular, the damping means is provided to fasten the function unit such that it is releasable by an operator only with the use of a tool. Alternatively, the function unit could be fastened so as to be exchangeable, in particular without the use of tools. The design of the system module according to the invention enables the function unit to be protected against mechanical action while being transported and used.

In a further design, it is proposed that the damping means span a function-unit receiving region, which is disposed at a distance from a housing body of the housing element, whereby a particularly high level of protection against mechanical action can be achieved. A “function-unit receiving region” is to be understood to mean, in particular, a region that is spanned by the damping means and provided to receive the function unit, and to do so, advantageously, without impairing a function of the function unit. Preferably, the function-unit receiving region is only partially enclosed by the damping means. In particular, the term “span” in this context is to be understood to mean that the damping means, via fastening points, defines a space in which the function unit is disposed, in particular at least partially, advantageously completely, in an operationally ready state. Preferably, at least one side, advantageously two sides, of the function-unit receiving region is/are not delimited by the housing element. This means, in particular, that the housing body is without a box base and/or, advantageously, of a box lid. Advantageously, the function-unit receiving region is disposed completely within a volume spanned by the housing body. Preferably, the function unit is disposed completely in the function-unit receiving region, in at least one operating state. The term “at a distance from” is to be understood to mean, in particular that the function unit disposed in the function-unit receiving region is disposed by the damping means such that the function unit and the housing element delimit a gap, preferably an air gap, that is disposed between the function unit and the housing element. Preferably, on all straight lines that intersect the function-unit receiving region and the housing element, there is either a damping means and/or an air gap disposed between the function-unit receiving region and the housing element. Preferably, the function-unit receiving region and the housing element are disposed at a distance of at least 2 mm, advantageously at least 5 mm, particularly advantageously at least 10 mm, from each other at all points.

It is furthermore proposed that the damping means be provided to transmit a force at least to edge regions of the housing element, thereby enabling advantageous damping to be achieved with a small expenditure of material. As a result, in particular, a low weight can be achieved. An “edge region” is to be understood to mean a face region that is convex along a distance, and that interconnects two substantially non-curved faces, in particular two outer faces of side walls of the housing element. Preferably, the edge region, on the distance between at least two defined points, which are preferably less than 30 mm apart on the distance, has a curvature of more than 45 degrees, particularly advantageously more than 60 degrees. In particular, the expression “transmit force” is to be understood to mean that the damping means supports a force, in particular from the function element, on the edge region, in at least one operating state.

It is additionally proposed that the housing element enclose on not more than five sides a function-unit receiving region that is spanned by the damping means, thereby making it possible to achieve a low weight and an advantageous ease of operation. In particular, “on not more than five sides” is to be understood to mean that at least substantially all regions of the function-unit receiving region are not delimited by the housing element, on at least one side, in at least one same direction. Preferably, the housing element has a housing body, which is realized as a frame. In this case, the housing element encloses the function-unit receiving region, spanned by the damping means, on four sides. “Substantially all regions” is to be understood to mean, in particular, at least 50%, advantageously at least 75%, particularly advantageously at least 90%, of a volume of the function-unit receiving region. Preferably, the system box or the further system module, when in a coupled state, is disposed on a side of the function-unit receiving region that is not enclosed by the housing element, with the result that the function unit is protected on all sides during transport. The function-unit receiving region, when in the coupled state, is in this case enclosed on all sides. Alternatively, the housing element could completely enclose the function-unit receiving region in at least one operating state. Advantageously, in this case, function elements attached to the housing element, in particular an operating interface, could be connected to the function unit via mechanically decoupled interfaces.

It is additionally proposed that the coupling device have at least one latching element that latches with a movement outward, such that the latching can be undone particularly easily by an operator, by a movement inward. In particular, the expression “latch with a movement outward” is to be understood to mean that the latching element, through a movement directed away from a center point of the housing element, effects a coupling with the system box or the further system module. A “latching element” is to be understood to mean, in particular, an element that, in a fastening operation, is elastically deflected in order subsequently to latch in behind a corresponding latching element, as a result of a clamping force.

It is furthermore proposed that the system module have a coupling means, which is provided for coupling to a system shelf so as to be releasable by an operator, thereby advantageously enabling the system module to be transported and stored. A “system shelf” is to be understood to mean, in particular, a shelf having at least two receiving regions that are provided to receive, and advantageously fix, a respective system box or system module. Preferably the system shelf has coupling means, and in particular latching means, corresponding to the coupling means of the housing element.

It is furthermore proposed that the function unit have at least one electronic function element. An “electronic function element” is to be understood to mean, in particular, an element having at least one electronic means that is provided to perform a function. An “electronic means” is to be understood to mean, in particular, a device that influences at least an electric current in a gas, in a conductor, in a vacuum and/or, advantageously, in a semiconductor. Preferably, the electronic means has at least one transistor, particularly preferably at least one microprocessor. Preferably, the function unit has at least one energy input. An “energy input” is to be understood to mean, in particular, a means provided to receive an energy for supply the function element. Preferably, the energy input has a mains power input and/or preferably a battery coupling means. The design of the function unit according to the invention enables functions to be performed through simple design means, and to be implemented in an advantageously protected manner.

In a further design, it is proposed that the function unit comprise at least one handle, which is provided for horizontal carrying, whereby advantageous transport can be achieved, in particular if the function unit constitutes part of an uppermost system module of a stack of a plurality of coupled system boxes or system modules. A “handle” is to be understood to mean, in particular, a device provided to be gripped, at least during carrying, by an operator. Preferably, the handle has a tubular grip region having a circumference of less than 20 cm. In particular, the expression “for horizontal carrying” is to be understood to mean that the handle is disposed on a perpendicular to a plane of main extent, which runs at least substantially through a center of gravity of the module. A “plane of main extent” is to be understood to mean a plane that is spanned by a maximum extent of the system module, parallel to an outside of the system module. A “center of gravity of the module” is to be understood to mean a center of gravity of the system module. In particular, in this context, “at least substantially” is to be understood to mean at a distance of less than 20 cm, advantageously less than 10 cm.

### DRAWING

Further advantages are given by the following description of the drawing. The drawing shows an exemplary embodiment of the invention. The drawing, the description and the claims contain numerous features in combination. Persons skilled in the art will also expediently consider the features individually and combine them to create appropriate further combinations.

### DESCRIPTION OF THE EXEMPLARY EMBODIMENT

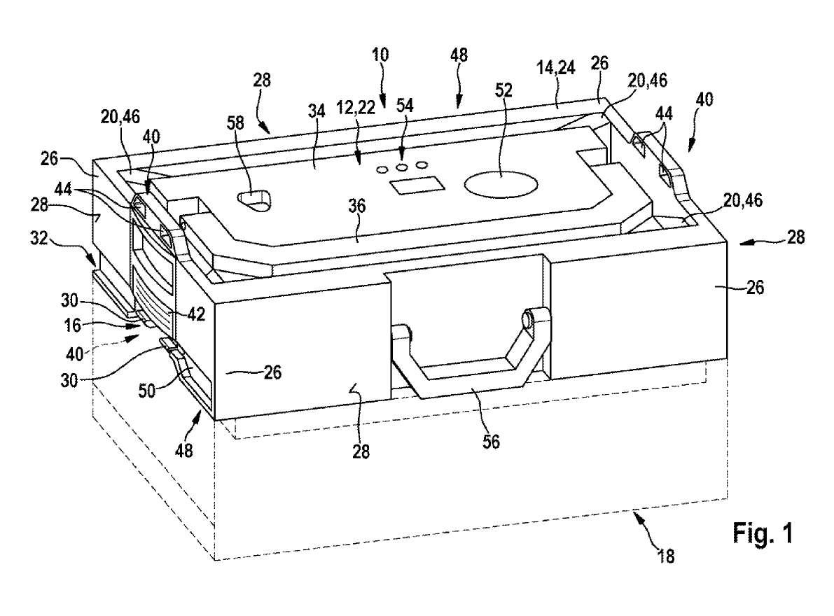

FIG. 1 shows a perspective representation of a box system, comprising a system module 10 according to the invention, which has a function unit 12, and comprising a system box 18. The system module 10 and the system box 18 each have a housing element 14 that has a first coupling device 16 and a second coupling device 40. The first coupling devices 16 are provided to be coupled to a second coupling device 40 of another system module or system box, for the purpose of creating a stack.

The coupling is realized so as to be releasable by an operator without the use of tools. For this purpose, the first coupling device 16 has latching elements 30 and operating elements 42. The latching elements 30 of the first coupling device 16 are realized as latching hooks. They are resiliently mounted. For the purpose of coupling, they latch together with latching elements of the second coupling device 40. The latching elements 44 of the second coupling device 40 are realized as latching eyes. The latching elements 30 of the first coupling device 16 latch with a movement outward. The operator can move the latching elements 30 of the first coupling device 16 inward, by pressing the operating elements 42, in order to undo the coupling. The system box 18 is transparent in the representation, such that the first coupling device 16 of the system 10 is visible.

The system module 10 and the system box 18 are coupled to form a stack. When in a coupled operating state, four edges of the system module 10 extend at least substantially along like straight lines, such as four edges of the system box 18. An outer plane spanned by a base of the system module 10 bears against an outer plane of the system box 18 that is spanned by a lid of the system box 18.

The system module 10 according to the invention has a damping means 20. During operation and transport, the damping means 20 fastens the function unit 12 to the housing element 14 in a damped manner. The damping means 20 has four damping elements 46. Alternatively, a damping means could have a different number of damping elements, considered appropriate by persons skilled in the art. The damping elements 46 are disposed at edge regions 26 of the housing element 14, on an inside of a housing body 24 of the housing element 14. The damping elements 46 fasten the function unit 12 to the housing element 14 so as to damp it against impact. For this purpose, the damping means 20 spans a function-unit receiving region 22, which is disposed at a distance from the housing body 24 of the housing element 14. If the system module 10 undergoes acceleration as a result of an impact acting upon the system module 10, the damping means 20 accelerate the function unit 12 with a lesser value, or in a less impact-like manner. For this purpose, the damping means 20 transmits a force to edge regions 26 of the housing element 14. The elasticity of the damping means 20 allows the function unit 12 to be displaced relative to the housing element 14, and causes it to be restored to the initial position. The damping means 20 has visco-elastic material. This includes rubber-type materials such as, for example, NBR, EPDM, TPE or other rubber-type materials considered appropriate by persons skilled in the art. Alternatively or additionally, the damping means could have elastic materials such as, in particular, other plastics and/or steel.

The housing element 14 encloses the function-unit receiving region 22 on four sides 28. Two sides 48 of the housing element 14, which have a greatest extent of area, are of an open design. Disposed on these sides 48, in the case of the system box 18, are a lid and a base. When in a stacked operating state, these sides bear against system boxes 18 or system modules. Alternatively or additionally, one side could be of open design, oriented perpendicularly in relation to these open sides 48.

The housing element 14 has a coupling means 32, which is provided to be coupled to a system shelf, not represented in greater detail here, so as to be releasable by an operator. The coupling means 32 comprises two slot-type recesses 50. The recesses 50 are disposed on two opposing sides of the housing element 14. The recesses 50 terminate in a stop. During transport, the system shelf fastens the housing element 14 in a releasable manner, at the stop. The opposing sides are aligned perpendicularly in relation to a base plane of the housing element 14. In addition, the housing element 14 has a handle 56, which is provided for horizontal carrying of the housing element 14. The handle 56 is disposed on a narrow side 28 of the housing element 14. The handle 56 is mounted in a swivelable manner. Alternatively, a handle could be realized so as to be integral with a housing body. The housing element 14 is provided to be put down on a side that faces away from the handle 56. This side, not represented in greater detail here, has an anti-slip coating that reduces impact.

The function unit 12 has an electronic function element 34. The electronic function element 34 is realized as a radio. It comprises a loudspeaker 52, an operator interface 54 and an energy input 58. The operator interface 54 has an on/off switch, and other input and output means considered appropriate by persons skilled in the art. The energy input 58 has a battery coupling means, not represented in greater detail here. In addition, the function unit 12 comprises a handle 36. The handle 36 is disposed on a side of the function unit 12 that faces toward the open side 48 of the housing element 14. The handle 36 is provided for horizontal carrying. It is mounted in a swivelable manner. For the purpose of horizontal carrying, the handle 36 is swiveled out of the function-unit receiving region 22. When in a swiveled-out operating state, the handle 36 is fixed in a swiveling direction, so as to be releasable by the operator.

1. A system module of a box system, comprising:
at least one function unit that is different from a hand tool;
at least one housing element including at least one coupling device configured to couple to a system box so as to be releasable by an operator; and
a damping mechanism configured to fasten the function unit to the housing element in a damped manner.

2. The system module as claimed in claim 1, wherein the damping mechanism spans a function-unit receiving region that is disposed at a distance from a housing body of the housing element.

3. The system module as claimed in claim 1, wherein the damping mechanism is configured to transmit a force at least to edge regions of the housing element.

4. The system module as claimed in claim 1, wherein the housing element encloses on not more than five sides a function-unit receiving region that is spanned by the damping mechanism.

5. The system module as claimed in claim 1, wherein the coupling device has at least one latching element that latches with a movement outward.

6. The system module as claimed in claim 1, further comprising a coupling mechanism configured to couple to a system shelf so as to be releasable by an operator.

7. The system module as claimed in claim 1, wherein the function unit has at least one electronic function element.

8. The system module as claimed in claim 1, wherein the function unit comprises at least one handle configured for horizontal carrying.

9. A housing element of a system module at least as claimed in claim 1.

10. A function unit of a system module at least as claimed in claim 1.

11. A box system, comprising:
a system module including:
at least one function unit that is different from a hand tool;
at least one housing element including at least one coupling device configured to couple to a system box so as to be releasable by an operator; and
a damping mechanism configured to fasten the function unit to the housing element in a damped manner; and
a system box.
